(19) United States
(12) Patent Application Publication
(10) Pub. No.: US 2018/0017838 A1
(43) Pub. Date: Jan. 18, 2018

(54) HIGH REFRACTIVE INDEX COMPOSITES FOR REFLECTIVE DISPLAYS

(71) Applicant: CLEARink Displays, Inc., FREMONT, CA (US)

(72) Inventor: Gary E. THOMAS, Eindhoven (NL)

(21) Appl. No.: 15/539,923

(22) PCT Filed: Dec. 21, 2015
(86) PCT No.: PCT/US15/66980

§ 371 Date: Jun. 26, 2017

Related U.S. Application Data
(60) Provisional application No. 62/098,333, filed on Dec. 31, 2014.

(51) Int. Cl. G02F 1/167; G02F 1/1335; G02B 5/02

(52) U.S. Cl. CPC G02F 1/167; G02F 1/133504; G02B 5/0242; G02B 5/0278

(57) ABSTRACT

To maximize the critical angle, θ_{c}, and the reflectance, R, in total internal reflection reflective image displays, the difference in the refractive indices between the surface of the transparent front sheet and the liquid medium comprising of electrophoretically mobile particles must be maximized. High index optical glasses may be used to fabricate the front sheet but are costly and difficult to manufacture with fine structural features. Polymers may be used to fabricate the transparent front sheet as they are cheaper and simpler to process into desired structures but typically have low indices of refraction. Polymers comprising of dispersed high refractive index particles may be used to increase the refractive index of the transparent front sheet. The polymers may be formed from UV-curable liquid monomers.

This application claims priority to the filing date of Provisional Application No. 62/098,333, filed Dec. 31, 2014, the specification of which is incorporated herein in its entirety.

### BACKGROUND

### Field

The disclosure generally relates to reflective image displays. Specifically, the disclosure relates to total internal reflection (TIR) image displays comprising high refractive index composite front sheets.

### Background

Conventional TIR-based reflective image displays comprise a transparent high refractive index front sheet with a plurality of convex protrusions in contact with a low refractive index fluid containing electrophoretically mobile particles. FIG. 1 depicts a cross-section of a portion of a prior art TIR-based reflective image display 100. Display 100 comprises a high refractive index transparent front sheet 102 with outward surface 104 facing viewer 106. Front sheet 102 further comprises a plurality of convex protrusions 108 on the inward side. The protrusions may be in the shape of a hemisphere 110 as shown in FIG. 1 or may be other shapes. The protrusions 110 may be embedded beads or may be part of a continuous front sheet.

Display 100 further comprises a transparent front electrode 112 on the inward surface of sheet 102, rear support sheet 114 with rear electrode layer 116. Within the cavity or containment reservoir formed by front sheet 102 and rear sheet 114 contains electrophoretically mobile particles 118 dispersed in low refractive index medium 120. Display 100 further comprises voltage bias source 122. Display 100 may further comprise at least one optional dielectric layer located on one or both of the electrodes 112, 116.

Application of a bias may move at least one particle 118 near the surface of the front sheet and into the evanescent wave region. At this location, TIR is frustrated and incident light rays may be absorbed creating a dark state. When particles are moved away from the front sheet 102 and out of the evanescent wave region light may be totally internally reflected. This creates a bright or white state of the display. Combinations of dark and bright states formed by movement of the particles 118 in and out of the evanescent wave region by the electrodes creates images. The images may convey information to viewer 106.

As is well known, the TIR interface between two media having different refractive indices is characterized by a critical angle θ_{c}. The critical angle characterizes the interface between the surface of the transparent front sheet (with refractive index η₁) 102, and the low refractive index fluid (with refractive index η₃) 120. Light rays incident upon the interface at angles less than θ_{c} may be transmitted through the interface. Light rays incident upon the interface at angles greater than θ_{c} may undergo TIR at the interface. A small critical angle is preferred at the TIR interface since this affords a large range of angles over which TIR may occur. The critical angle, θ_{c}, is calculated by the following equation (Eq. 1):

$${θ}_{c} = {sin}^{- 1} ( \frac{{η}_{3}}{{η}_{1}} ) \qquad ( 1 )$$

It is important to minimize the critical angle, θ_{c}, to allow for a large range of angles of incident light rays over which TIR may occur and thus maximize the reflectance of the display. It may be prudent to have a fluid medium 120 with preferably as small a refractive index (η₃) as possible and to have a transparent front sheet 102 composed of a material having a refractive index (η₁) preferably as large as possible. The reflectance, R, may be calculated for each individual protrusion 110 of the transparent front sheet 102 as follows in equation 2 (Eq. 2):

$$R = 1 - {( \frac{{η}_{3}}{{η}_{1}} )}^{2} \qquad ( 2 )$$

It should be noted that in order to calculate the reflectance, R, of the entire front sheet 102 comprising of the plurality of convex protrusions 108 a multiplier must be used to account for the fill factor of the individual protrusions 110. The calculations described herein are for an individual protrusion 110 and are for illustrative purposes only.

The effect of the refractive index on θ_{c} and R is illustrated by comparing two different hypothetical systems, A and B. It is assumed that each system uses the same liquid medium with a refractive index η₃=1.27. In system A, the refractive index (η₁) of the protrusions 110 is assumed to be 1.5 while the protrusions 110 of system B have a higher refractive index (η₁) of 1.8. As a result, system A with the lower refractive index (η₁) of each protrusion 110 has a higher critical angle (θ_{c}) of about 58° and lower reflectance (R) of about 28%. System B with a higher refractive index of the protrusions (72 ₁) 110 has a lower critical angle of about 45° and higher reflectance of about 50%. See the data listed in Table 1.

TABLE 1
Calculation of critical angle (θ_{c}) and reflectance (R) as function
of the refractive index (η₁) of the protrusions.

| | η₃ | | θ_{c} (critical | R |
|---|---|---|---|---|
| System | (medium) | η₁ (bead) | angle) | (reflectance) |
| A | 1.27 | 1.5 | 58° | 28% |
| B | 1.27 | 1.8 | 45° | 50% |

In order to maximize reflectance and minimize the critical angle it is important to maximize the difference between the refractive indices of the protrusions 110 and the liquid medium 120 (which may include electrophoretic particles 118).

For a large number of applications in optical devices, such as TIR-based reflective image displays, materials having a high index of refraction are required or would be advantageous with respect to traditional materials such as polymers or standard glasses (e.g. soda-lime glasses and borosilicate glasses). Both polymers and standard glasses have indices of refraction in the range of about 1.4-1.6. For many optical applications, it is necessary to structure the material to achieve the required optical functionality. Optical glasses are known to have refractive indices up to about 2.0 but the possibilities to structure such glasses are limited, often time-consuming and costly. Polymers, on the other hand, are limited in their range of refractive indices but can be easily structured by a variety of methods such as molding, casting, embossing and extrusion. Although polymers are known with a refractive index of greater than 1.6, their optical properties are often insufficient for many applications.

It is known that polymer composite materials may be prepared with higher refractive indices by doping the polymer with high-index inorganic nanoparticles of a size range where optical scattering effects do not occur. However, the doping process itself is difficult with polymers which are normally solid at room temperature or which have a very high viscosity. Alternatively, one may use ultra-violet (UV) light curing (curing may also be referred to as polymerizing) monomers as the basis for preparing doped, high-index polymers that may easily be molded using standard processes to produce structured optical devices or subcomponents for such devices. UV-cured polymers have the advantage that most are low-viscosity liquid monomers at room temperature in the uncured state. Such liquids may easily be doped with the above-mentioned high-index nanoparticles. They may be structured using a variety of known processes and cured with UV light to form a solid, structured, high-index layer or body.

### BRIEF DESCRIPTION OF DRAWINGS

These and other embodiments of the disclosure will be discussed with reference to the following exemplary and non-limiting illustrations, in which like elements are numbered similarly, and where:

FIG. 1 depicts a cross-section of a portion of a prior art TIR-based reflective image display;

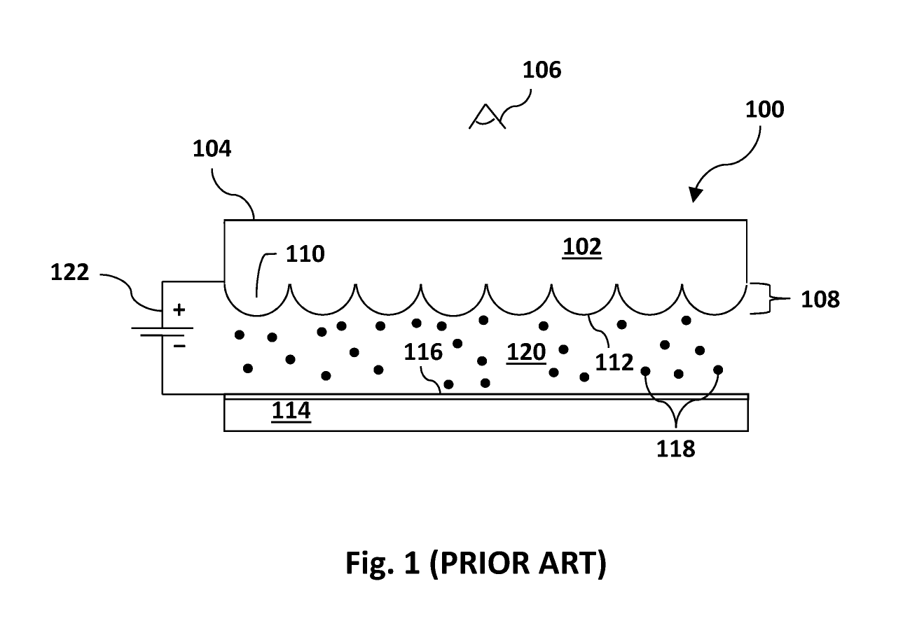

FIG. 2 depicts a cross-section of a portion of a continuous high refractive index composite front sheet of a TIR-based reflective image display;

FIG. 3 depicts a cross-section of a portion of a TIR-based reflective image display comprising a high refractive index composite front sheet; and

FIG. 4 schematically illustrates an exemplary system for implementing an embodiment of the disclosure.

### DETAILED DESCRIPTION

The exemplary embodiments provided herein improve reflectance of TIR displays. In an exemplary embodiment, the disclosure provides a composite high refractive index transparent front sheet. The composite high refractive index transparent front sheet comprises high refractive index particles dispersed in a polymer matrix. The composite high refractive index transparent front sheet increases the difference of the refractive indices of the front sheet and low refractive index medium containing electrophoretically mobile particles. As a result the reflectance properties of the display increases.

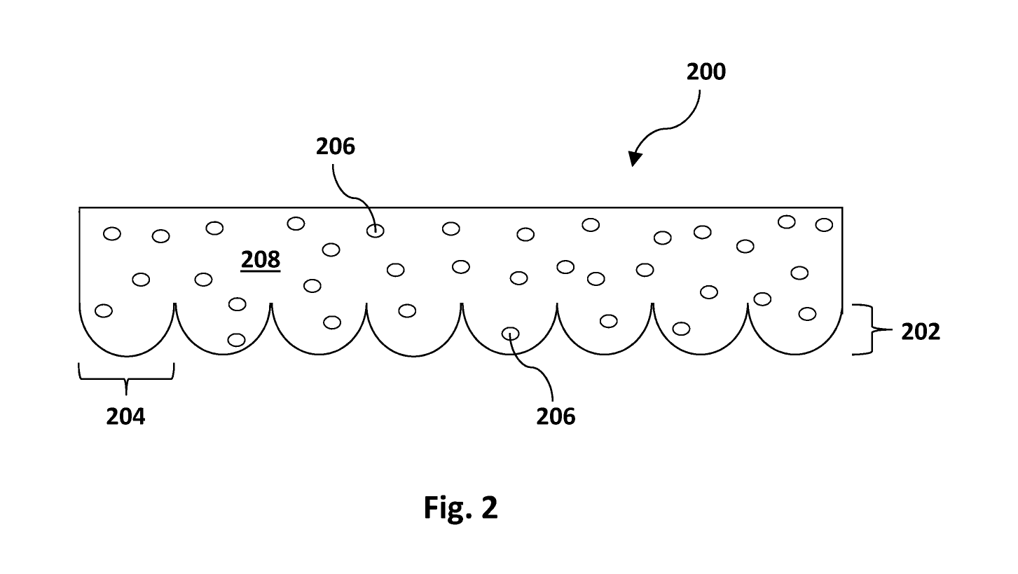

FIG. 2 depicts a cross-section of a portion of a continuous high refractive index composite front sheet of a TIR-based reflective image display. This is a close-up view of an optically transparent composite front sheet 200 comprising a plurality of convex protrusions 202 on the inward surface. In an exemplary embodiment the plurality of convex protrusions 202 comprises at least one protrusion 204 in the shape of a hemisphere as illustrated in FIG. 2. In other embodiments, front sheet 200 may comprise beads embedded on the inward surface.

In an exemplary embodiment, composite front sheet 200 comprises high index particles 206 dispersed in an optically transparent polymer matrix 208 such that the refractive index of the composite is higher than in the absence of particles 206. In some embodiments, the diameter of the particles 206 may be less than about 400 nanometers. In other embodiments, the size of the particles 206 may be less than about 250 nanometers. In an exemplary embodiment, the particles 206 may be have an average size of about 10-20 nanometers or less. In certain embodiments, the particles may have a refractive index of about 1.65 or higher. In some embodiments, the particles may have a refractive index of about 1.8 or higher. In other embodiments, the particles may have a refractive index of about 2.0 or higher. The particles 206 may be comprised of TiO₂, diamond, cubic zirconia, ZnS, ZnSe, germanium or other similar high refractive index optical glass materials or a combination thereof.

In an exemplary embodiment, composite front sheet 200 may comprise high index particles 206 of at least about 5% by volume. In other embodiments, front sheet 200 may comprise high index particles 206 of at least about 5% to about 90% by volume. As the volume of particles 206 increases in the polymer matrix 208, the resulting index of refraction of the hemispheres 204 may also increase. It may be advantageous to maximize the volume % of the high index particles 206 in the polymer matrix 208 to maximize the refractive index. Many factors may need to be considered when determining the volume fraction of particles 206 in the polymer matrix 208 such as processability, brittleness, tensile strength and optical properties. In an exemplary embodiment the composite front sheet 200 may have a refractive index of about 1.65 or higher. In other embodiments, the composite front sheet 200 may have a refractive index of about 1.85 or higher.

In an exemplary embodiment, polymer matrix 208 may be formed from a UV-curable monomer. Polymer matrix 208 may comprise polystyrene, polyacrylate, polymethacrylate, polylactone, polylactam, polycyclic ether, polycyclic acetal, polyvinyl ether, poly-N-vinyl carbazole or polycyclic siloxane-based polymers or a combination thereof. In an exemplary embodiment, poly-1,6-hexane-diol diacrylate may be used as the polymer matrix 208.

In an exemplary method to create a composite front sheet 200, high index particles 206 may be suspended and substantially uniformly dispersed in a liquid medium comprising of a monomer and photo-initiator. The suspension may be poured into a mold or over a structured surface comprising a negative image of the desired structure. The suspension may then be irradiated by UV-light in order to cure or polymerize the monomer and freeze the high index particles 206 in place in a substantially uniform manner throughout the polymer matrix 208.

In other embodiments, polymer matrix 208 may be a melt processable polymer. High index particles 206 may be dispersed in a high temperature liquid state of polymer 208 then cooled to room temperature in a mold to create composite front sheet 200. In other embodiments composite front sheet 200 may be formed by embossing or stamping.

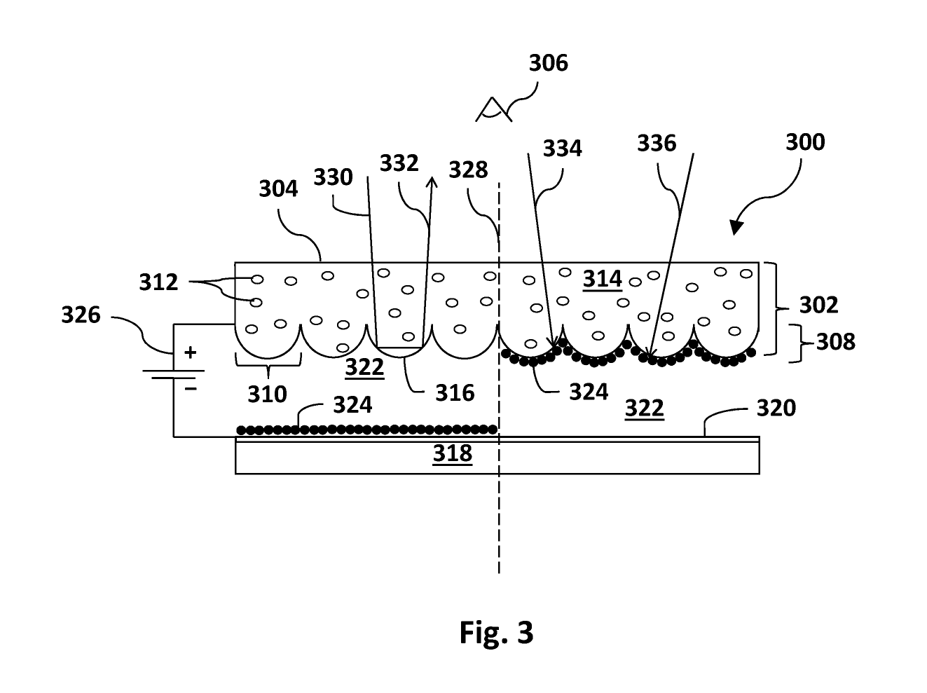

FIG. 3 depicts a cross-section of a portion of a TIR-based reflective image display comprising a high refractive index composite front sheet. Display 300 embodiment comprises an optically transparent composite front sheet 302 with an outward surface 304 facing viewer 306 and a plurality of convex protrusions 308 on the inward side. Sheet 302 is similar to sheet 200 in FIG. 2. In an exemplary embodiment, display 300 comprises at least one protrusion 310 in the shape of a hemisphere. In an exemplary embodiment the composite front sheet 302 may have a refractive index of about 1.65 or higher. In other embodiments, the composite front sheet 302 may have a refractive index of about 1.85 or higher.

Composite sheet 302 may further comprise high refractive index particles 312 dispersed in an optically transparent polymer matrix 314. In some embodiments the diameter of the particles 312 may be less than about 400 nanometers. In other embodiments, particles 312 may be less than about 250 nanometers. In an exemplary embodiment the particles 312 may be about 10-20 nanometers in average diameter. In some embodiments, the particles may have a refractive index of about 1.8 or higher. In other embodiments the particles may have a refractive index of about 2.0 or higher. The particles 312 may be comprised of TiO₂, diamond, cubic zirconia, ZnS, ZnSe, germanium or other similar high refractive index optical glass materials or a combination thereof.

In an exemplary embodiment, polymer matrix 314 may be formed from a UV-curable monomer. Polymer matrix 314 may comprise polystyrene, polyacrylate, polymethacrylate, polylactone, polylactam, polycyclic ether, polycyclic acetal, polyvinyl ether, poly-N-vinyl carbazole or polycyclic siloxane-based polymers or a combination thereof. In an exemplary embodiment, poly-1,6-hexane-diol diacrylate may be used as the polymer matrix 314.

In other embodiments, polymer matrix 314 may be a melt-processable polymer. High index particles 312 may be dispersed in a high temperature liquid state of polymer 314 then cooled to room temperature in a mold to create composite front sheet 302. In still other embodiments, composite front sheet 302 may be formed by embossing or stamping.

Display 300 may further comprise a transparent front electrode layer 316 on the inward surface of sheet 302. Layer 316 may comprise at least one of indium tin oxide (ITO), electrically conducting polymer or conductive metal nanoparticles dispersed in a clear polymer matrix.

Display 300 comprises rear support sheet 318 and rear electrode layer 320. Rear electrode layer 320 may be located on the inward surface of sheet 318. Rear electrode layer 320 may comprise a thin film transistor (TFT) array, direct drive patterned array or a passive matrix array of electrodes.

Display 300 may further comprise at least one dielectric layer (not shown) on the surface of one or both the front 316 and rear 320 electrode layers. A dielectric layer may protect the electrode layers. The dielectric layer may comprise at least one of an organic polymer or inorganic material. In an exemplary embodiment, the dielectric layer may comprise parylene. In other embodiments the dielectric layer may comprise a halogenated parylene. In other embodiments the dielectric layer may comprise polyimide or SiO₂.

Display 300 comprises a low refractive index medium 322 within the cavity or containment reservoir formed by the composite front sheet 302 and rear support sheet 318. Medium 322 may be air or a liquid. In an exemplary embodiment, medium 322 may be an inert, fluorinated liquid such as a fluorinated hydrocarbon. In an exemplary embodiment, medium 322 may be Fluorinert™ perfluorinated hydrocarbon liquid available from 3M, St. Paul, Minn.

Display 300 further comprises a plurality of light absorbing, electrophoretically mobile particles 324 dispersed in medium 322. Particles 324 may be a dye or a pigment or a combination thereof. Particles 324 may be at least one of carbon black, a metal or metal oxide. Particles 324 may comprise a positive polarity or a negative polarity or both a positive and negative polarity.

Display 300 in FIG. 3 may further comprise an optional voltage bias source 326. Bias source 326 may apply a negative or positive bias across medium 322 comprising electrophoretically mobile particles 324. The applied bias may move at least one particle 324 through medium 322 towards the front electrode 316 or rear electrode 320 layers.

Display 300 may be operated as follows. A bias of opposite polarity to certain particles 324 may be applied by voltage source 326 at the rear electrode layer 320. At least one of the electrophoretically mobile particles 324 may move near and collect at the rear electrode 320 as shown on the left side of dotted line 328. Incident light rays may pass through the composite front sheet 302 and may be totally internally reflected at the surface of the plurality of hemispherical protrusions 308. This is represented by incident light ray 330 in FIG. 3 that is totally internally reflected and exits the display as reflected light ray 332 towards viewer 306. This may create a bright or light state of the display as observed by a viewer.

A bias may be applied by source 326 of opposite polarity of the electrophoretically mobile particles 324 at the front electrode layer 316 as shown to the right of dotted line 328. Particles 324 may move towards and collect at the front electrode 316. Particle 324 may enter the evanescent wave region and frustrate TIR. Incident light rays may pass through the composite front sheet 302 and may be absorbed by particles 324 that have collected at the front electrode 316. This is illustrated by incident light rays 334 and 336 in FIG. 3. This may create a dark state of the display.

In other embodiments, any of the image displays comprising a transparent composite front sheet containing high refractive index particles may further include at least one spacer structure. Spacer structures may be used in order to control the gap between the front and rear electrodes. Spacer structures may be used to support the various layers in the displays. The spacer structures may be in the shape of circular or oval beads, blocks, cylinders or other geometrical shapes or combinations thereof. The spacer structures may comprise glass, metal, plastic or other resin.

In other embodiments, any of the image displays comprising a transparent composite front sheet containing high refractive index particles may further include at least one edge seal. An edge seal may be a thermally or photo-chemically cured material. The edge seal may comprise one or more of an epoxy, silicone or other polymer based material.

In other embodiments, the image displays comprising a transparent composite front sheet containing high refractive index particles may further include at least one sidewall (may also be referred to as cross-walls). Sidewalls limit particle settling, drift and diffusion to improve display performance and bistability. Sidewalls may be located within the light modulation layer. Sidewalls may completely or partially extend from the front electrode, rear electrode or both the front and rear electrodes. Sidewalls may comprise plastic or glass.

In an exemplary embodiment, a directional front light may be employed with the display embodiments comprising a transparent composite front sheet containing high refractive index particles. The light source may be a light emitting diode (LED), a cold-cathode fluorescent lamp (CCFL) or a surface mount technology (SMT) incandescent lamp.

In some embodiments a light diffusive layer may be used with the display embodiments comprising a transparent composite front sheet containing high refractive index particles to “soften” the reflected light observed by the viewer. In other embodiments a light diffusive layer may be used in combination with a front light.

Various control mechanism for the invention may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

In some embodiments, a tangible machine-readable non-transitory storage medium that contains instructions may be used in combination with the reflective displays comprising a transparent composite front sheet containing high refractive index particles. In other embodiments the tangible machine-readable non-transitory storage medium may be further used in combination with one or more processors.

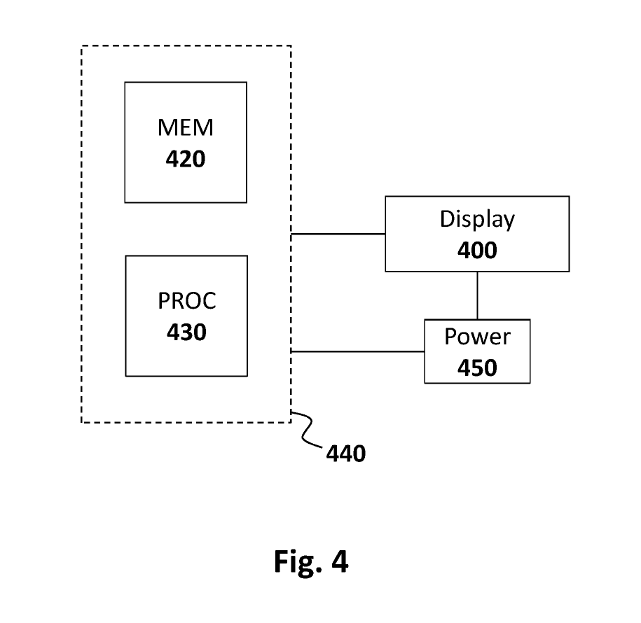

FIG. 4 shows an exemplary system for controlling a display according to one embodiment of the disclosure. In FIG. 4, display 400 is controlled by controller 440 having processor 430 and memory 420. Other control mechanisms and/or devices may be included in controller 440 without departing from the disclosed principles. Controller 440 may define hardware, software or a combination of hardware and software. For example, controller 440 may define a processor programmed with instructions (e.g., firmware). Processor 430 may be an actual processor or a virtual processor or a combination thereof. Similarly, memory 420 may be an actual memory (i.e., hardware) or virtual memory (i.e., software) or a combination thereof.

Memory 420 may store instructions to be executed by processor 430 for driving display 400. The instructions may be configured to operate display 400. In one embodiment, the instructions may include biasing electrodes associated with display 400 (not shown) through power supply 450. When biased, the electrodes may cause movement of electrophoretic particles to a region to thereby absorb or reflect light that passes through the transparent composite front sheet containing high refractive index particles. By appropriately biasing the electrodes (not shown), mobile light absorbing particles (e.g., particles 324, FIG. 3) may be attracted to a location at or near the transparent composite front sheet (e.g., front sheet 302 or 314, FIG. 3) containing high refractive index particles in order to absorb or reflect the incoming light. Absorbing the incoming light creates a dark state. Reflecting the incoming light creates a light state.

In some embodiments, a porous reflective layer may be used in combination with the reflective displays comprising a transparent composite front sheet containing high refractive index particles. The porous reflective layer may be interposed between the front and rear electrode layers. In other embodiments the rear electrode may be located on the surface of the porous electrode layer.

In the display embodiments described herein, they may be used in such applications including electronic book readers, portable computers, tablet computers, cellular telephones, smart cards, signs, watches, wearables, shelf labels, flash drives and outdoor billboards or outdoor signs comprising a display.

The following exemplary and non-limiting embodiments provide various implementations of the disclosure.

Example 1 is directed to an image display, comprising: a front sheet with a refractive index of about 1.65 or higher, the front sheet having an outward surface and an inward surface; a plurality of protrusions formed on the inward surface of the front sheet, at least one of the plurality of the protrusions further comprising a plurality of high refractive index nanoparticles in a polymer matrix, wherein the plurality of high refractive index nanoparticles have a refractive index of about 1.8 or higher; and a backplane electrode layer, wherein the backplane electrode and the inward surface of the front sheet forms a cavity.

Example 2 is directed to the image display of example 1, wherein the front sheet comprises an optically transparent sheet.

Example 3 is directed to the image display of examples 1 or 2, wherein the plurality of protrusions define a plurality of beads formed on an inward surface of the front sheet.

Example 4 is directed to the image display of any preceding example, wherein the plurality of protrusions define a plurality of hemispherical protrusions comprising the polymer matrix.

Example 5 is directed to the image display of any preceding example, wherein the cavity is configured to receive an electrophoresis medium with a plurality of electrophoretically mobile particles suspended in the medium.

Example 6 is directed to the image display of any preceding example, further comprising a voltage source for applying a voltage across the cavity to move the plurality of electrophoretically mobile particles within the medium.

Example 7 is directed to the image display of any preceding example, wherein the plurality of high refractive index nanoparticles in a polymer matrix have a diameter of about 400 nm or less.

Example 8 is directed to the image display of any preceding example, wherein the plurality of high refractive index nanoparticles in a polymer matrix have a diameter of about 250 nm or less.

Example 9 is directed to the image display of any preceding example, wherein the polymer matrix comprises polystyrene, polyacrylate, polymethacrylate, polylactone, polylactam, polycyclic ether, polycyclic acetal, polyvinyl ether, poly-N-vinyl carbazole, poly-1,6-hexane-diol diacrylate or a polycyclic siloxane or a combination thereof.

Example 10 is directed to the image display of any preceding example, wherein the polymer matrix is formed by UV-curing a monomer.

Example 11 is directed to a method to form an image display, the method comprising: providing a front sheet with a refractive index of about 1.65 or higher, the front sheet having an outward surface and an inward surface; forming a plurality of protrusions on the inward surface of the front sheet, at least one of the plurality of the protrusions further comprising a plurality of high refractive index nanoparticles in a polymer matrix, wherein the plurality of high refractive index nanoparticles have a refractive index of about 1.8 or higher; and forming a backplane electrode layer facing the plurality of protrusions to form a cavity between the backplane electrode and the plurality of protrusions.

Example 12 is directed to the method of example 11, wherein forming the plurality of protrusions further comprises forming a plurality of beads over the inward surface of the front sheet.

Example 13 is directed to the method of examples 11 or 12, wherein forming the plurality of protrusions further comprises forming a plurality of hemispherical protrusions including the polymer matrix.

Example 14 is directed to the method of any preceding example, wherein the cavity is configured to receive an electrophoresis medium with a plurality of electrophoretically mobile particles suspended in the medium.

Example 15 is directed to the method of any preceding example, further comprising applying a voltage across the cavity to move the plurality of electrophoretically mobile particles within the medium.

Example 16 is directed to the method of any preceding example, wherein the plurality of high refractive index nanoparticles in a polymer matrix have a diameter of about 400 nm or less.

Example 17 is directed to the method of any preceding example, wherein the plurality of high refractive index nanoparticles in a polymer matrix have a diameter of about 250 nm or less.

Example 18 is directed to the method of any preceding example, wherein the polymer matrix comprises polystyrene, polyacrylate, polymethacrylate, polylactone, polylactam, polycyclic ether, polycyclic acetal, polyvinyl ether, poly-N-vinyl carbazole, poly-1,6-hexane-diol diacrylate or a polycyclic siloxane or a combination thereof.

Example 19 is directed to the method of any preceding example, wherein the polymer matrix is formed by UV-curing a monomer.

While the principles of the disclosure have been illustrated in relation to the exemplary embodiments shown herein, the principles of the disclosure are not limited thereto and include any modification, variation or permutation thereof.

What is claimed is:

1. An image display, comprising:
a front sheet with a refractive index of about 1.65 or higher, the front sheet having an outward surface and an inward surface;
a plurality of protrusions formed on the inward surface of the front sheet, at least one of the plurality of the protrusions further comprising a plurality of high refractive index nanoparticles in a polymer matrix, wherein the plurality of high refractive index nanoparticles have a refractive index of about 1.8 or higher; and
a backplane electrode layer, wherein the backplane electrode and the inward surface of the front sheet forms a cavity.

2. The image display of claim 1, wherein the front sheet comprises an optically transparent sheet.

3. The image display of claim 1, wherein the plurality of protrusions define a plurality of beads formed on an inward surface of the front sheet.

4. The image display of claim 1, wherein the plurality of protrusions define a plurality of hemispherical protrusions comprising the polymer matrix.

5. The image display of claim 1, wherein the cavity is configured to receive an electrophoresis medium with a plurality of electrophoretically mobile particles suspended in the medium.

6. The image display of claim 5, further comprising a voltage source for applying a voltage across the cavity to move the plurality of electrophoretically mobile particles within the medium.

7. The image display of claim 1, wherein the plurality of high refractive index nanoparticles in a polymer matrix have a diameter of about 400 nm or less.

8. The image display of claim 1, wherein the plurality of high refractive index nanoparticles in a polymer matrix have a diameter of about 250 nm or less.

9. The image display of claim 1, wherein the polymer matrix comprises polystyrene, polyacrylate, polymethacrylate, polylactone, polylactam, polycyclic ether, polycyclic acetal, polyvinyl ether, poly-N-vinyl carbazole, poly-1,6-hexane-diol diacrylate or a polycyclic siloxane or a combination thereof.

10. The image display of claim 1, wherein the polymer matrix is formed by UV-curing a monomer.

11. A method to form an image display, the method comprising:
providing a front sheet with a refractive index of about 1.65 or higher, the front sheet having an outward surface and an inward surface;
forming a plurality of protrusions on the inward surface of the front sheet, at least one of the plurality of the protrusions further comprising a plurality of high refractive index nanoparticles in a polymer matrix, wherein the plurality of high refractive index nanoparticles have a refractive index of about 1.8 or higher; and
forming a backplane electrode layer facing the plurality of protrusions to form a cavity between the backplane electrode and the plurality of protrusions.

12. The method of claim 11, wherein forming the plurality of protrusions further comprises forming a plurality of beads over the inward surface of the front sheet.

13. The method of claim 11, wherein forming the plurality of protrusions further comprises forming a plurality of hemispherical protrusions including the polymer matrix.

14. The method of claim 11, wherein the cavity is configured to receive an electrophoresis medium with a plurality of electrophoretically mobile particles suspended in the medium.

15. The method of claim 14, further comprising applying a voltage across the cavity to move the plurality of electrophoretically mobile particles within the medium.

16. The method of claim 11, wherein the plurality of high refractive index nanoparticles in a polymer matrix have a diameter of about 400 nm or less.

17. The method of claim 11, wherein the plurality of high refractive index nanoparticles in a polymer matrix have a diameter of about 250 nm or less.

18. The method of claim 11, wherein the polymer matrix comprises polystyrene, polyacrylate, polymethacrylate, polylactone, polylactam, polycyclic ether, polycyclic acetal, polyvinyl ether, poly-N-vinyl carbazole, poly-1,6-hexane-diol diacrylate or a polycyclic siloxane or a combination thereof.

19. The method of claim 11, wherein the polymer matrix is formed by UV-curing a monomer.
